(19) United States
(12) Patent Application Publication
(10) Pub. No.: US 2002/0049664 A1
(43) Pub. Date: Apr. 25, 2002

(54) Multiple, concurrent dynamic auction emulation for networked environments

(76) Inventors: Kenneth E. Hoffman, Bellevue, WA (US); David M. Vice, Seattle, WA (US)

Correspondence Address: Stephen M. Evans, Graybeal Jackson Haley LLP, Suite 350, 155-108th Avenue NE, Bellevue, WA, 98004-5901, US

(21) Appl. No.: 09/898,899

(22) Filed: Jul. 2, 2001

Related U.S. Application Data
(60) Provisional application No. 60/215,346, filed on Jun. 30, 2000.
(60) Provisional application No. 60/215,350, filed on Jun. 30, 2000.
(60) Provisional application No. 60/215,349, filed on Jun. 30, 2000.
(60) Provisional application No. 60/215,347, filed on Jun. 30, 2000.
(60) Provisional application No. 60/215,348, filed on Jun. 30, 2000.

(51) Int. Cl. G06F 17/60

(52) U.S. Cl. 705/37

(57) ABSTRACT

The invention concerns systems and methods for implementing systems that permit multiple, concurrent real time live or dynamic auction emulations in a networked environment. The systems include an auction database manager (ADM) component operatively linked to a rules based auctioneer (RBA) component and auction user interface manager (UIM) component. The ADM component manages data relevant to the auction environment such as bid parameters, lot data parameters, and user preference parameters; auction history data such as bid history data; and completed auction archive data. The RBA component manages the interactive nature of the live auction emulations by defining the parameters for data presentation to bidders, and causing the same to be delivered to relevant bidders via the UIM component. It also handles basic input and output calls to and from the ADM component. The UIM component transforms the RBA component output to specific display and communications protocols for devices possessed or accessible by the bidders based upon data acquired from each participating bidder. Input from active bidders is transformed by the UIM component and delivered to the RBA component for processing. These components, when integrated into a networked environment, permit multiple, concurrent, real time auctions that emulate real world live auctions wherein the price for an auction lot is determined not by an expiration of time but by a final highest bid. Methods are disclosed for carrying out the operations of the described components, as well as converting conventional static online auctions into dynamic auctions.

### FILED OF THE INVENTION

The present invention pertains to systems and methods for implementing systems that permit multiple, concurrent dynamic auction emulations for wide area network environments. More particularly, the invention is directed to means for permitting a plurality of bidders to simultaneously bid on a plurality of auction lots using established criteria for conducting each auction. The invention also is directed to converting a traditional online static auction into a dynamic auction.

### BACKGROUND OF THE INVENTION

Real world or dynamic auctions are intended to maximize the value received for an auction lot subject to bidding. As is well known, a lot is presented to a discrete group of interested bidders by an auctioneer. The auctioneer establishes the minimum starting bid, and moderates the bidding by a) accepting a valid bid offered by at least one bidder in the group of bidders, and b) offering a new bid for acceptance by at least bidder in the group of interested bidders. The process continues until no additional bidders for a given accepted bid will accept the next bid offered by the auctioneer.

As is also well known, the group of bidders is generally fixed; the number of participants is unique during the bidding process for any given lot. Moreover, because each lot auction is unique, the composition of the auctioneer is also generally fixed. The consequence of this auction model is that a given group of bidders can only participate in a single auction at any given time, and an auctioneer can only moderate a single auction at any given time, since a person can only be in one place at any given time.

Attempts have been made in the online environment to emulate a dynamic or real auction environment. Commercial undertakings as exemplified by eBay.com represent the most common approach. Taking advantage of a computer network environment, these attempts provide multiple simultaneous auctions wherein bidders have a set time limit for presenting their bids for a given lot. For any given lot, a starting bid is presented to all potential bidders, and the bidders are given unlimited opportunities to offer money for the lot within the set time period. As the auction data is updated and the user ascertains the state of bidding, the user may elect to increase his or her bid, usually in an amount pre-established by the auction software. However, it is common for a bidder not to increase his or her bid to a maximum until more information concerning other bidders in the group is known, e.g., waiting until near the close of the auction for the possibility of being the last bidder prior to the close and not having to reach his or her maximum bid.

While the foregoing approach may be good for the bidder in that he or she may obtain the lot without having to present a maximum bid, it is deficient in two ways: first, the maximum possible price is usually not obtained since other bidders, willing to offer more money for the lot, may have missed the close; second, some bidders may be frustrated since they were not given sufficient time in which to place higher bids in order to obtain the desired lot. In a conventional live or dynamic auction, neither of these deficiencies would have been encountered.

Based on the foregoing, it is clear that present online auction models do not approximate the experience of dynamic live auctions, nor meet the expectations of its users or providers. What is needed is a more realistic emulation of live auctions for use in an online environment, and an ability to convert static online auctions into dynamic online auctions that approximate the real world experience.

### SUMMARY OF THE INVENTION

The present invention concerns systems and methods for creating multiple, concurrent real time dynamic auctions in a networked online environment. By changing the paradigm relating to online auctions, it is now possible to achieve a faithful emulation of a real world dynamic auction where the bidding experience is preserved and maximum price for an auction lot is obtained, while exploiting the benefits of conducting online commerce. The invention is directed to both establishing online one or more real time dynamic auctions as well as converting traditional static auctions to one or more real time dynamic auctions.

An aspect of the invention is implemented in a networked computer environment wherein at least one bidder is operatively linked to a central computer. The operative linking of the bidder is accomplished preferably in the form of at least two computing or network client devices having a processor, memory, an input device such as a keyboard and/or pointing device, an output device such as a monitor, and network communications abilities such as a network interface or modem, wherein the computers are linked to the central computer by way of a communications link, e.g., wireline, wireless, or radio frequency. In this basic environment, a competitive bidding environment with one live bidder is created by using one or more proxy bidders, which will be described in more detail below.

Most desirably, a large plurality of bidders is so linked to the central computer as may be found in a global communications network, e.g., the Internet. Preferably, bidder computers will have conventional operating systems, e.g., Linux, Macintosh OS8; Windows 95, 98, me, 2000, XP; Palm OS; and conventional client applications, e.g., HTML compatible, Java-based, or XML compatible browser applications, or native platform specific browser applications, as well as notification client applications, e.g., e-mail (POP3), instant messaging, and paging applications. Alternatively or in addition to traditional network client devices such as computers, other forms network client devices include wireless devices, set top boxes, and similar consumer technologies.

The central or server computer may comprise one or more computers, but shall be referred to in the singular for convenience. The central computer, which may be a server-type computer, is linked to the same communications network as the at least one network client device, although the communications link need only be able to transmit data to and receive data from the at least one user regardless of the mode of communication. In addition to the communications link, the central computer has sufficient resources to operate computer applications capable of carrying out aspects of the invention. While the specifics shall be identified below, general attributes include an operating system such as Microsoft's Windows NT/2000, Linux, Unix, and other multitasking or multithreading operating systems. Applications adaptable to the invention include Oracle products and Microsoft SQL. In addition to the foregoing, implementation of the invention can use a variety of programming languages and shelf-based applications. Nevertheless, preferred programming or pseudo programming languages include Java, JavaScript, C, C++, Visual Basic, VBScript, and ActiveX controls. Data presentation and acquisition across the network is preferably carried out by common browser-based protocol such as HTML code, XML code, Active Server Pages (ASP), JSP, SOAP, JMS, and others. However, any form of data presentation and acquisition is considered within the scope of the invention, e.g., instant messaging.

In preferred form, the central computer comprises three discrete server-class computers operatively linked together, although a single computer or more than three computers can be used and is considered a design factor. The central computer is responsible for a given set of processes, which will now be described. The first set of processes relates to the acquisition, processing, and dissemination of auction related data and is handled by the Auction Database Manager (ADM) component or layer. The ADM layer includes one or more data tables having information comprising auction lot data, proxy and pre-existing bid histories, previous and current bidder identification and profiles, and communications protocol and addresses. This information may be obtained from a pre-existing database and/or from information obtained from other components or layers of the invention embodiment. In addition to acquiring, processing, and disseminating the aforementioned data, the ADM initiates the Rules-Based Action (RBA) component or layer, stores data obtained from the RBA, provides historic data to the RBA upon query, and provides historic data to a main auction archive.

The RBA layer operates to control operation of the overall invention, and utilizes the data resources of the ADM and a User Interface Manager (UIM) component or layer, which will be described later. Using a pre-determined rule set that depends upon the information presented by the ADM, a series of actions are carried out. While the order of the actions may be relevant to any given situation, they are presented here in a non-limiting order.

One action that the RBA must undertake is the resolution of any proxy bids that may apply to the given auction. As noted previously, bidder information may comprise proxies for certain auction lots. Because the auction will accept bids up to a certain limit, it is often desirable to compare proxy maximums to ascertain the composition of proxy bidders. Naturally, a software simulation can be used so that as the auction information is refreshed for the benefit of the active bidders to appear that there is more activity, and thus increases the “auction experience” of the bidders.

Presuming that the proxy bids are resolved prior to the start of the auction, the UIM is called to begin bidder notification and/or solicitation actions, as determined in part by the data stored in the ADM database. In turn, bidder information obtained by the iterations of the UIM is passed to the RBA and ADM. Once established criteria such as minimum bid, reserve price, identification of bidders, and possible resolution of proxy bids are met, the auction commences. Once started, bid offer and acceptance information is passed between all layers of the invention, and similar information is passed to all active bidders. The bidding and accepting process will continue until there is no higher bid acceptance by any of the participants for a given period of time.

As noted previously, the UIM handles all bidder interface issues. Depending upon presentation features ascertained from a bidder by bidder polling and/or by profile information present in the ADM, the UIM will control multimedia matters. Outgoing data will be presented to a bidder based upon preferences and bidder devices, while incoming data from the bidders will be parsed and transferred to the ADM and RBA components.

Another aspect of the invention comprises methods and systems for converting an online static auction with an expiration time to a dynamic real-time auction that ends when the absolute highest bid for a lot has been reached. As a condition prerequisite to auction conversion, there must exist a valid and operational static online auction. While not considered to be part of the invention, the existence of the static auction is necessary for this aspect of the invention to be carried out. Therefore, to provide the reader with sufficient background, the essential components of a static auction will be described.

Because the primary purpose of the static auction as relative to this aspect of the invention is to provide information concerning the seller, the lot, the bidders, and the static auction bidding history, the mode of static auction operation is not critical. However, it is necessary that at least part of the previously described information be accessible by the dynamic online auction software applications described earlier. Thus, the form of invention implementation may be driven in part by a desire or need to remain compatible with the existing static auction software and operating system platform such that acquisition of data from the static auction database is not unnecessarily complicated. Consequently, interapplication data exchange is desired, but not necessary (a separate conversion application can be used instead). In preferred form, the existing static online auction and the invention operate in a server environment such as Windows NT, Windows 2000, Unix (and common variations thereof), Linux, and others, and the application software is similarly based, e.g., Microsoft SQL Server and Access, Oracle database products and others.

In one embodiment, the invention concerns a dynamic online auction. A method for conducting such an auction uses a communications network having a central computer for hosting the dynamic auction and providing/receiving electronic data. The central computer is operatively linked to a first group having at least one bidder and has at least one auction lot subject to bidding. The method then comprises a) providing electronic data to the first group comprising information relating to the first auction lot and an initial bid; b) receiving bid information from at least one bidder of the first group concerning the first auction lot; c) providing electronic data to the first group comprising information relating to the received bid information concerning the first auction lot; d) repeating b) and c) until no further bid information is received from any bidder concerning the first auction lot when no bid higher than the last received bid is received within a pre-established period of time, thus concluding bid receiving; and f) providing electronic data to the first group comprising information relating to the last received bid information

An aspect of this embodiment addresses the issue of proxy bidders. In the event that an interested user cannot participate in the dynamic auction, it is possible to submit a proxy bid. The proxy bid can be handled in several ways, including submitting it at any time during the dynamic auction, at a predetermined threshold (as determined by duration of the auction or present bid value), or incrementally (a percentage of the total bid value is submitted based upon the duration of the auction or present bid value, up to the full value of the proxy bid). In this manner, the auction remains dynamic even if the number of live bidders is low. Moreover, in this manner and if done incrementally, a proxy bidder may not have to reach his or her authorized maximum as the host administers submission of the incremental proxy bids.

Another aspect of this embodiment permits more than one auction to be concurrently run. In this situation, a second or more groups are identified and participate in the dynamic auction. The various groups are not necessarily discrete; a bidder in one group can also be a bidder in another group.

Having addressed several foundational matters and what constitutes a dynamic auction, the conversion aspect of the invention will now be described. A method for converting an online static auction with an expiration time into an online dynamic auction comprises a) establishing an agreement between a seller and an auction provider to permit a conversion from a static auction into a dynamic auction; b) meeting predetermined criteria for permitting conversion of the auction; c) passing control of the auction from the static software application to a dynamic software application; d) establishing a list of at least one dynamic bidder (in the case where there is only one live bidder, it is necessary to have at least one proxy bid established, which may be presented to the live bidder or may be incrementally presented to emulate a live auction; e) communicating with the at least one bidder to indicate the beginning of the dynamic auction; and f) conducting the online dynamic auction. Because overall implementation of this feature of the invention is highly situation specific, numerous variations exist. The following examples are intended to illustrate the flexibility of the invention, and should not be construed as limitations thereof.

The agreement in a) can be handled simply as default system policy that the seller agrees by placing an item on the system for auction. In this case, a seller wishing to submit his or her lot for auction impliedly agrees to permit a conversion to take place upon the occurrence of predetermined conditions or events. Alternatively, the agreement can be made as part of the application process whereby the seller authorizes or requests that the lot be made eligible for conversion and the auction operator explicitly approves the lot for auction conversion. Additionally, the auction operator may, based on criteria including but not limited to price, item type, auction activity for similar items, etc. request authorization from the seller for the item to be made eligible for conversion. The request for authorization may be accomplished in a similar manner as with respect to bidder notification as set forth below, or by other means such as telephone contact.

The meeting of criteria to begin conversion in b) also has great flexibility, and can be generally stated as being dependent upon one or more auction variables: expiration of static auction, fixed time, reserve price, last bid for lot, bidding activity, subject matter of lot, size of lot, seller defined criteria, etc., as well as resource constraints such as server computing resources. For example, the rules or policies for conversion to take place may depend upon the expiration time of the static auction. Thus, conversion may take place “10 minutes before expiration of the static auction.” Another example is to establish a fixed time for commencement, e.g., the time of day. In this example, having a predetermined time for commencement can be used to load balance the system or provide more opportunities to bid during times of high activity. Another possibility is based upon price of the lot: the operator may limit conversion to items that have reached a reserve price or other price target. Still another viable variable for beginning the conversion process relates to the total number of bidders that have engaged in the static auction. For example, it may be a more efficient use of system resources to only convert popular items that have already had specific level of activity. Alternatively, the conversion criteria can be based upon the number of bidders presently participating in the static auction. This would limit even more the number of items that would actually undergo the conversion process. In this case the conversion would only take place if a predetermined number of active bidders were participating in the static auction.

In order to assess the state of the aforementioned variables in addition to others not specifically identified above, the static online auction database and the dynamic online database should be constructed to track at least some of these variables. In a preferred embodiment, the ADM component or layer will either have this information ported to it, or will access the static auction database for selected information.

The passing of control in c) can be accomplished by several means. For example, the passing of control can be by issuing a stop static auction command and directing further I/O operations to the dynamic auction application. An alternative would be to utilize existing static auction system interrupts that permit such actions. Another alternative would be to modify the static auction source code and related compiled iteration to include porting of the desired information. At the same time that auction control is passed to the dynamic auction application, bidders wishing to participate in the static auction are notified of the change in status, e.g., the expected auction interface is replaced by a suitable notification of the conversion to dynamic mode.

The list of bidders in d) can be ascertained from many different sources, many of which derive importance based upon auction operator criteria. The final list of bidders to contact and invite to the dynamic auction can come from numerous sources, three of which are particularly relevant.

A first source of users for the dynamic auction notification list is derived from bid data stored in the static auction database. The bidders may be those presently engaging in active bidding in the static auction, those who are currently or have bid in the static auction, and/or those who have at any time and for any reason utilized the static auction system resources.

A second source of users is derived from a database having identification and modes of contact for interested users. Interested users are those who may have requested a service to notify them when a certain class of item is auctioned. They may have already received notice of the static auction.

A third source of users is derived from third party leads. In this scheme, potential bidders to the auction operator may engage in the dynamic auction. Sources for such bidders are likely to result from notified bidders communicating the existence of the dynamic auction to these persons who subsequently access the auction system resources.

The notification in e) uses one or more modes of bidder notification as determined by user defined preferences associated with obtained database information, system policy protocols, or combinations thereof. The mode of bidder notification of conversion may be as simple as presenting a revised static auction display data to current bidders, or may be as complex as wireless notification. The following examples are intended to provide a range of messaging possibilities, but not limit the modes of notification.

### BRIEF DESCRIPTION OF THE DRAWINGS

FIG. 1 is a simple data or process flow diagram for basic implementation of the invention;

FIG. 2 is a data and process flow diagram for the ADM;

FIG. 3 is a data and process flow diagram for the UIM;

FIG. 4 is a data and process flow diagram for enabling the conversion of a static auction to the dynamic auction of the invention;

FIG. 5 is a data and process flow diagram for carrying out a conversion from a static auction to a dynamic auction according to a feature of the invention; and

FIG. 6 is a data and process flow diagram for carrying out a conversion of a direct sales and agent sales model to a dynamic auction according to a feature of the invention.

### DETAILED DESCRIPTION OF THE INVENTION

The following discussion is presented to enable a person skilled in the art to make and use the invention. Various modifications to the preferred embodiment will be readily apparent to those skilled in the art, and the generic principles herein may be applied to other embodiments and applications without departing from the spirit and scope of the present invention as defined by the appended claims. Thus, the present invention is not intended to be limited to the embodiment show, but is to be accorded the widest scope consistent with the principles and features disclosed herein.

Multiple, Concurrent Real Time Dynamic Auction

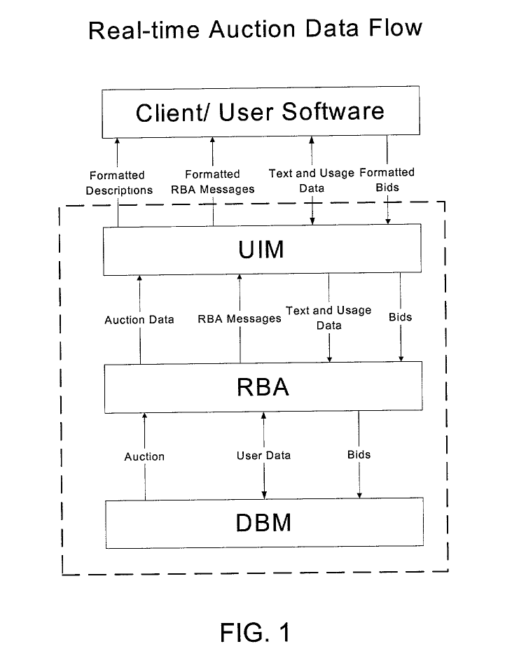

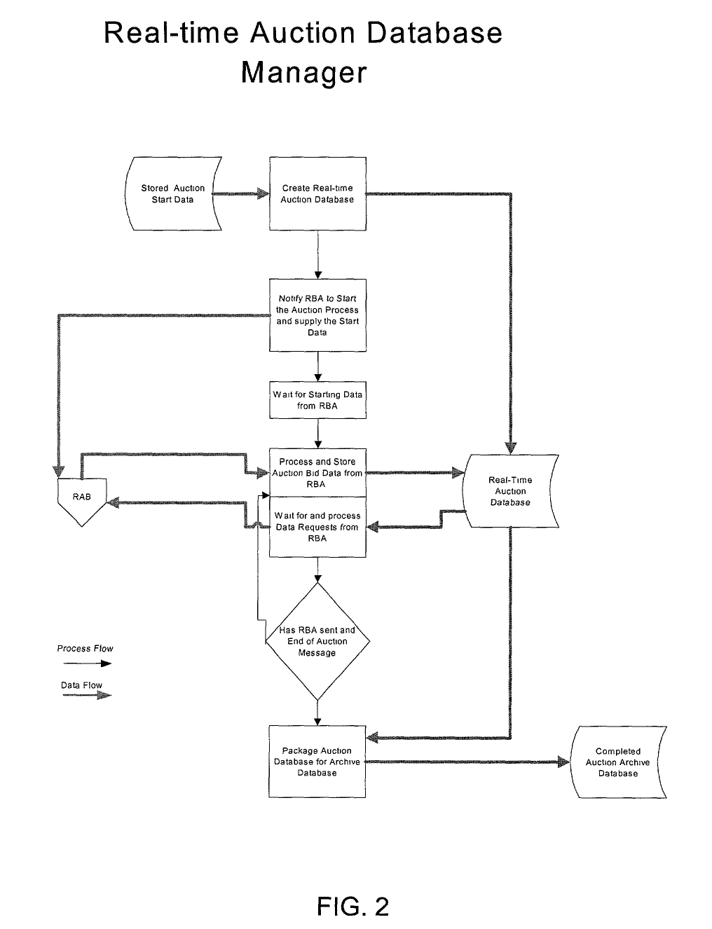

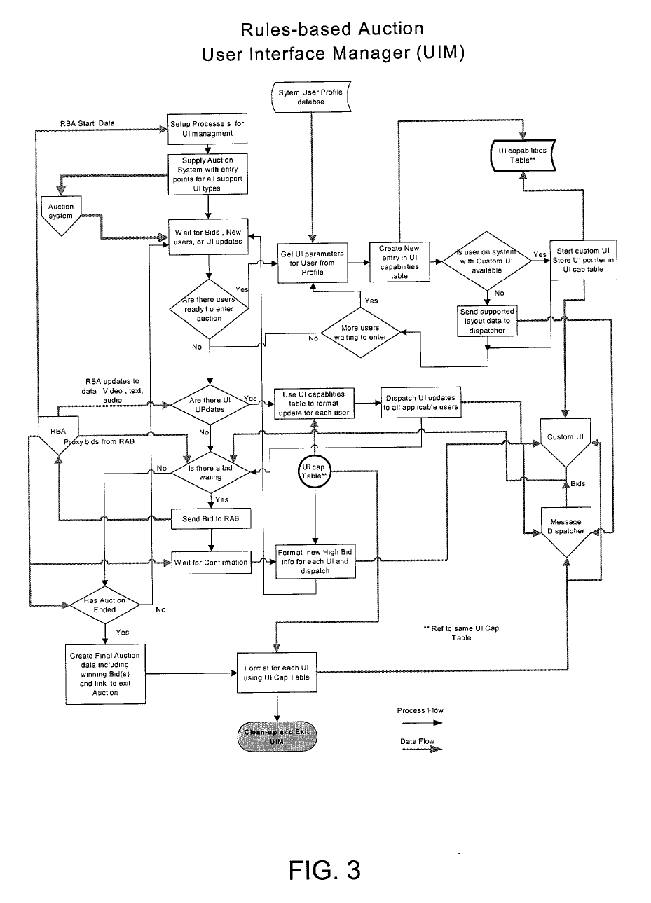

Turning first to FIGS. 1 through 4, the major components of the invention can be broken down into the following parts, which will now be described.

Auction Database Manager (ADM)

Create the initial auction environment: Every auction begins with a set of parameters and information. This can include starting bid, reserve prices, number of identical lots available, lot description data (including multi-media data), and any pre-registered proxy bids. Once the system activates a real-time auction, the ADM creates the database structures needed start the auction and maintain the auction history. The information used to seed the ADM database is preferably obtained from a master auction database. Depending upon design criteria, the ADM can manage one or more databases or data tables, although a single database structure comprising multiple data tables for each auction lot is preferred.

Maintain and provide a real-time auction history: In any auction, a complete bid history is important for legal and business needs. In a rule-based auction, the history is a resource for the rules processor. The ADM will not only maintain the bid history but will provide access to the bid history by the RBA.

Package the completed auction record: Once the auction is competed, the ADM will create a completed auction record for storage in an auction archive.

Rules Based Auctioneer (RBA)

Using data from the ADM, the RBA controls the timing of all events in the real-time auction. The following processes are administered by the RBA.

Present auction lot data: The RBA can time the presentation of different aspects of the lot's description. It can transmit text, images, audio, and/or video data at key times to try to enhance bidding activity. The UIM will filter and format this data for each bidder's presentation device.

Increment and prompt bidding: The RBA will use rules to decide when and how much to increment the next requested bid. It will also use these rules to prompt specific bidders for bids in an attempt to keep them active. The UIM will filter and format these prompts for each bidder's presentation device.

Manage proxy bids: Based upon the nature of the rules as a whole or as applied to one or more auction lots, proxy bids may be resolved before the beginning of the real-time auction with the winning proxy bid becoming the opening bid for the real-time auction. The rules may also cause the proxy bids to be presented in real-time during the auction to increase the level of participation by live bidders.

Provide auction data to the Auction Database Manager: When the RBA acquires a bid via the UIM, it will provide the ADM with the user, bid, and time of bid information.

Auction User Interface Manager (UIM)

Initialize user interface: When each new user/bidder joins the auction, this component will access his or her profile (usually but not necessarily stored in the ADM database) and determine the nature of that user's interface. Thereafter, data sent to the user from the ADM via the RBA will be transformed by the UIM to maximize the capabilities of the user's data interface as described below.

Manage data flow to active bidders: Bidders on devices like PCs and TV based devices may have an interface that will include various types of multimedia capabilities. There may be still or video images of the auction lot, as well as audio. There may be synthetic or live multimedia presentations of other participants or even the computer auctioneer. Other bidders may be on simpler or portable appliances that have limited abilities. The UIM makes sure that all messages and data streams provided are appropriate to the user's client interface.

End auction environment: When the auction ends, the UIM will provide end of auction lot data and will manage any remaining logistics. This management may include taking orders from multiple winning bidders in a Dutch auction.

Gather bidder “Click Data”: The UIM may also gather and store bidder click data. This data will provide system operators and other data on how users are interacting with the UI. Are they constantly viewing and replaying video, scrolling text? Are they moving between the interface and other applications regularly? All of this information may also be used to spot motivated bidders by providing context sensitive programming.

These three layers or components work in unison to provide a rich, interactive, real-time auction environment for network bidders. The ultimate goal is to maximize auction revenues for the sellers and the auction providers.

Conversion of Static Auction to Dynamic Auction

As bid maximization is an objective of the present invention, it may be desirable to convert a static online auction into a dynamic auction. While the prior embodiment concerned the ability to provide multiple, concurrent real time dynamic auction emulations, the following embodiment relates to the ability to convert a static online auction into a dynamic online auction, whether there are several instances of it or only one.

In a traditional online auction, a seller (a person, group of people, or organization desirous of selling goods and/or services, i.e., a lot), contacts an operator of online auction services to request inclusion of a lot in an upcoming auction. If the lot is approved by the operator for auction, the lot and the description of the lot are entered into a database that is accessible by the operator's auction software. At a designated time, the lot is made available to buyers/bidders who have a specified period of time in which to place desired bids.

As noted previously, true competitive bidding in a static online auction usually does not occur until near the expiration time for the auction. In such scenarios, the winning bidder may be the one with the faster online connection, or may just be the bidder who was “lucky” enough to place the last bid prior to the expiration time limit; this leaves the seller not able to realize the highest bid. However, if the expiration time limit was not the conclusory event, competitive bidding could continue until the group last minute bidders were reduced to a very small number.

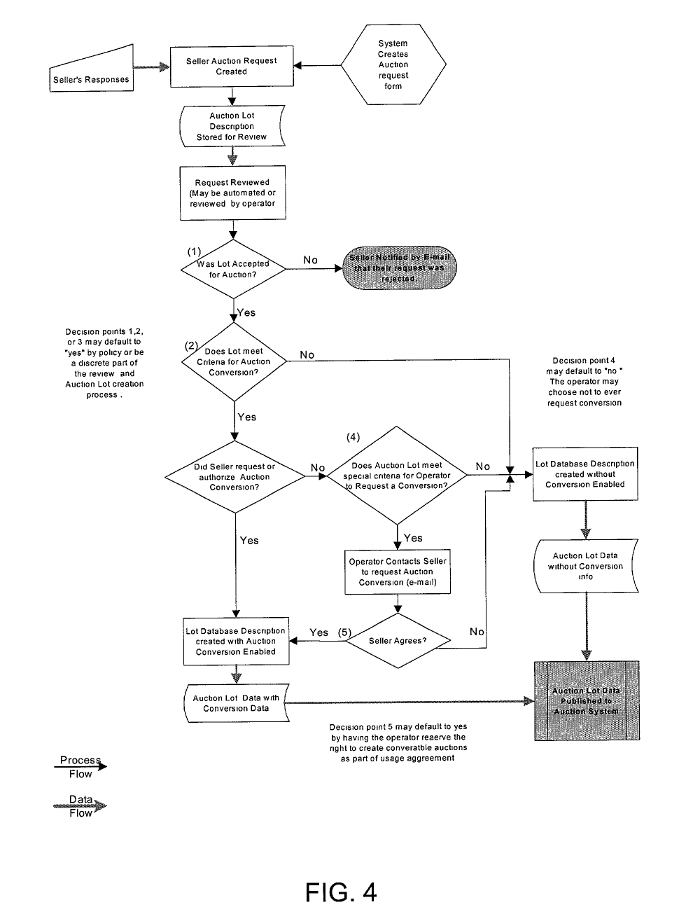

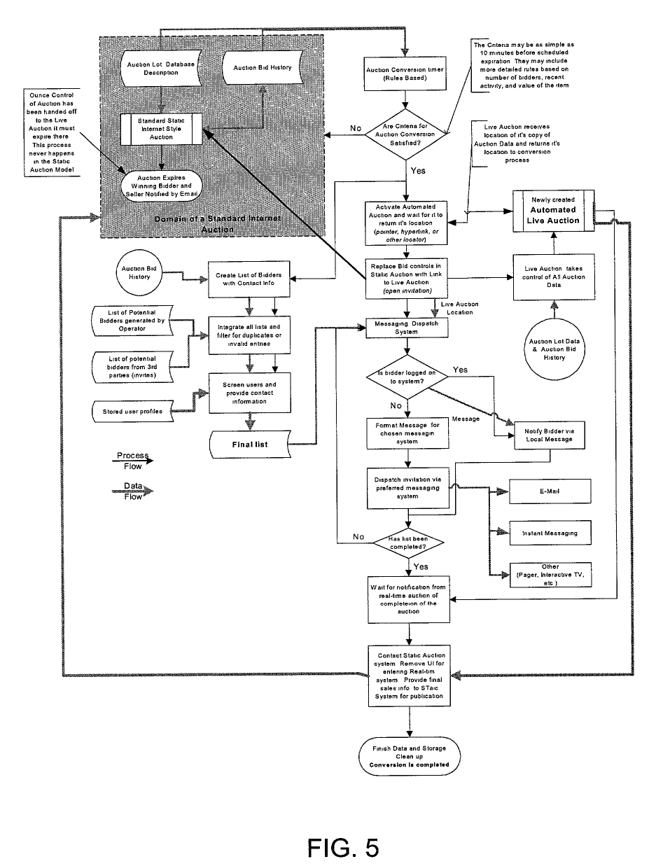

Turning then to FIGS. 4 and 5, a basic online auction is shown wherein a conversion feature exists. In FIG. 4, an auction system such as AuctionPlace or a custom application is used to create a seller request form. The application process by which a seller requests an auction does not have to be a real-time interactive system. This process is the simple collection of data from a seller. The easiest implementation uses HTML-based forms. HTML-based forms allow the seller to take advantage of many features available in current Web browser technology. However, alternative means for acquiring seller data include email, phone-based systems, mail, and/or facsimile transmissions.

Included in the seller data is information concerning the seller's consent to convert the auction to a maximum bid price model. If the seller consents to such a model, then the present invention may be implemented as will now be described.

Once the auction lot information has been received and temporarily stored, the operator reviews the lot for conformance with its auction policies. If the lot is rejected, the seller is notified. Presuming that the lot has been accepted, the data is assessed to determine if auction conversion is possible. If conversion is not possible, for example the seller specifically requested that conversion not be applied, then the database information for the lot will be appended to deny execution of a conversion routine, and the auction will take place in a convention time-limited manner. However, if the lot is capable of conversion, two possibilities exist: the lot may be inherently convertible and the seller did not exclude the conversion option, and/or the seller data may indicate consent to convert. In the first possibility, the auction lot meets the criteria for conversion but the seller did not authorize conversion. If conversion is possible but not requested, the operator can contact the seller, preferably by email, to solicit conversion instructions. If consent is not received, then the database information for the lot will be appended to deny execution of a conversion routine. However, if the seller agrees, then the database information for the lot will be appended to permit execution of a conversion routine. The same appending of the database information for the lot occurs if the seller authorizes conversion.

Having established the possibility of auction conversion in FIG. 4, attention is now directed to FIG. 5 wherein the conversion process from static to dynamic auction model is shown. As detailed previously, the invention concerns the conversion of a standard static online auction into a competitive bidding dynamic auction. Therefore, it is presumed that a static auction is in process, and will be converted at some point during the bidding process. For example, a conversion timer algorithm can be employed wherein a conversion will take place during the final minutes of the auction.

Based on a set of rules defined by the operator, the timer will determine how long before the listed expiration time of the static auction conversion will take place. The “timer” will also insure that other non-time based criteria for conversion are met. Examples include the following: Price based rules, and activity based rules. This is a server-based process and can be implemented in any language compatible with the rest of the server system. (Examples: would include independent Java, Perl, C or C++ based routines, or stored procedures/routines in a SQL database.)

Once the conversion timer has determined all time and none time based criteria, the conversion process is initiated. The first step in conversion is transferring control of the auction lot data and the entire auction bid data (history) to the real-time auction system. This hand off of control must ensure that no last minute bids in the static auction are lost. The order of this transfer is important.

The conversion system must request a unique identifier for the new real-time auction. It must also provide the new process with the location of the static auction data. Once the conversion system has the unique identification of the new real-time auction, it must provide the information to the static auction system. The static auction system will then remove any user interface that allows bidding in the static environment. This user interface is replaced with a user interface to allow viewers of the static auction to enter the real time auction any time until the real-time auction ends. In a preferred embodiment, the interface is determined by the UIM on the server side.

Once the static auction has disabled bidding, the real-time auction may either work directly with the auction data as provided or copy it to a system optimized for real-time auctions such as was previously described. This data should not be copied until the real-time auction system has confirmation that static bidding is disabled, so as to preserve the integrity of data.

While the transfer of control is being processed, another part of the system begins the process of compiling the final list of bidders to contact and invite to the real-time auction. In order to provide sufficient notice to interested bidders, the preferred embodiment obtains a collection of bidders from various sources. Particularly, the list of bidders to contact can come from as many as three sources.

Bidder list from auction bid history: This for many implementations may be the only source of bidders to contact. These are pre-qualified bidders who have shown an interest in the specific auction lot. They are registered bidders comprehensive contact information in their user profiles managed by the ADM component.

Auction operator generated bidder list: This list will include bidders that have expressed an interest in the type of item being auctioned and requested notification of static and or live auctions of this type of item.

Third party leads: Bidders will have the option of requesting that an invitation to this auction be sent to others that they believe will be interested.

Once this final list of qualified bidders to be contacted is compiled and filtered to remove duplicates and invalid entries, it is passed to the message dispatch process. If a bidder is already logged on the system, then a local notification is given to the logged on bidder. The mode of such notification may include delivering a custom HTML based message or JavaScript window indicating that the conversion is about to take place. For potential bidders not logged on to the system, alternative notification means are employed. These notification means can include sending an email to the prospective bidder, online instant messaging, a POTS based communication using a pre-recorded message, wireless paging such as by pager or cellular telephone, broadcast means such as radio or television, or similar notification technology. The messaging is preferably delivered in advance of the conversion to permit the prospective bidder sufficient time in which to access the auction resources.

After all messaging activities have been completed and verified, the dynamic auction is permitted to conclude as a matter of course in a manner known to those persons skilled in the art and as described earlier herein. The data obtained from the dynamic auction is preferably made available to the static auction system for final processing, or may be handled by the ADM, as the case may be.

Conversion of a Direct Sales or Agent Sales Model to a Dynamic Auction

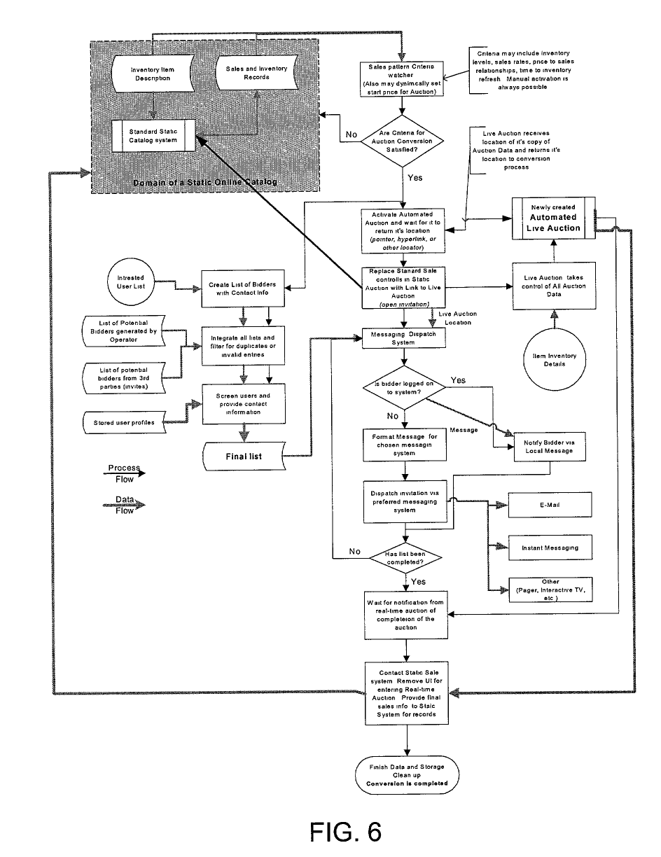

Turning to FIG. 6, it can be seen that the conversion feature of the present invention can be applied to other business sales models other than static auctions. In particular, the conversion ability can optimize the sales price for inventoried goods, and improve inventory flow by automatic conversion to a dynamic auction.

In a direct sales scenario, the seller has complete authority to determine the price of the goods presented for sale. Thus, the process in FIG. 4 relating to the agreement building processes are not carried out. Moreover, the criteria used to evaluate the desirability for conversion is generally different from that used in a static to dynamic auction conversion scenario. Thus, data relating to inventory, sales rates, expected inventory levels over time, clearance objectives, and other factors become relevant. This same data may be used to determine starting bid levels based upon pre-established criteria, or criteria established by human intervention.

In addition to the foregoing and because there may be more than one item up for sale, the conversion may implement a “Dutch” style auction wherein a bidder selects a price for the good(s) and subsequent bidders may select a lower price at a later point in time, but only if any goods remain. Since this feature of the invention is directed to the interrupting a traditional sales event and not specifically directed to implementing a particular auction style in lieu thereof, the type of substituted auction is a design consideration. Instead, the objective is to provide an alternative form of conducting the sales of one or more items available in an online environment.

An additional to the above-noted difference, a group of available bidders is likely not to be engaged in the purchasing direct sales activities with respect to the identified goods when conversion takes place. Thus, and unlike the conversion of FIG. 5, an interested bidder list will likely be consulted to notify potentially interested bidders of the conversion event. The means for notification are similar to those used to notify bidders with respect to the previously described embodiments.

The major difference with respect to agent sales concerns the establishment of a minimum bid price. As agent or consignment sales (also including broker sales) are administered by a proxy, the owner of the goods will usually establish minimum pricing structures. Consequently, the agreement process to establish pricing criteria must still be carried out. However, this process can be carried out by conventional means in addition to electronic data transfer means.

What is claimed:

1. A method for conducting a dynamic auction in a virtual environment comprising a communications network having a central computer for hosting the dynamic auction and providing/receiving electronic data, the central computer being operatively linked to a first group having at least one bidder, the method comprising:
a) identifying a first auction lot subject to bidding;
b) providing electronic data to the first group comprising information relating to the first auction lot and an initial bid;
c) receiving bid information from at least one bidder of the first group concerning the first auction lot;
d) providing electronic data to the first group comprising information relating to the received bid information concerning the first auction lot;
e) repeating c) and d) until no further bid information is received from any bidder concerning the first auction lot when no bid higher than the last received bid is received within a pre-established period of time, thus concluding bid receiving; and
f) providing electronic data to the first group comprising information relating to the last received bid information.

2. The method of claim 1 wherein the virtual environment further comprises a second group having at least one bidder, the method comprising:
g) identifying a second auction lot subject to bidding after b) but prior to f);
h) providing electronic data to the second group comprising information relating to the second auction lot and an initial bid after b) but prior to f);
i) receiving bid information from at least one bidder of the second group concerning the second auction lot;
j) providing electronic data to the second group comprising information relating to the received bid information concerning the second auction lot;
k) repeating i) and j) until no further bid information is received from any bidder concerning the second auction lot when no bid higher than the last received bid is received within a pre-established period of time, thus concluding bid receiving; and
l) providing electronic data to the second group comprising information relating to the last received bid information.

3. The method of claim 2 wherein at least one bidder of the first group is also a bidder in the second group.

4. The method of claim 1 wherein the first group further comprises at least one proxy bid and wherein the proxy bid is placed after a first bid is received from the first group.

5. The method of claim 2 wherein the second group further comprises at least one proxy bid and wherein the proxy bid is placed after a first bid is received from the second group.

6. The method of claim 1 wherein the first group further comprises at least one proxy bid administered by the central computer to establish a virtual bidder, and wherein the proxy bid has a value and a fraction of the value is communicated to the first group after a first bid is received from the first group but before the conclusion of bid receiving.

7. The method of claim 6 wherein a progressively higher fraction of the value is communicated to the first group while any subsequent bids therefrom are received, up to a final communication when the proxy bid value has been reached.

8. The method of claim 1 wherein the conclusion of bid receiving occurs when a predetermined bid value has been received.

9. The method of claim 1 wherein the first auction lot was subject to a static auction.

10. A method for converting an online static auction having a pre-established expiration time limit into an online dynamic auction using a communications network having a server-type computer for providing/receiving electronic data operatively linked to a first group, and data generated and received by the static auction, the method comprising:
a) during the static auction, obtaining conversion data from the static auction, the conversion data being selected from the group consisting of number of potential bidders, number of active bidders, number of bids received, value of highest bid, time remaining until auction expiration, and value of auction lot;
b) comparing the conversion data with conversion criteria; and
c) transferring auction control to a dynamic auction application when the conversion criteria has been met.

11. The method of claim 10 wherein the conversion criteria concerns bidder related data.

12. The method of claim 10 wherein the conversion criteria concerns auction lot related data.

13. The method of claim 10 wherein the dynamic auction application performs the method of claim 1.

14. The method of claim 10 further comprising terminating the static auction at least as early as the transferring of auction control to the dynamic auction application.

15. A computer program stored in a physical medium for use in a server computer operatively coupled to a data communications network comprising at least two bidder input/output apparatus, the program comprising:
an ADM component for maintaining data comprising auction lot information and prospective bidder information including bidder input and output communications preferences;
a RDA component for administering multiple, concurrent real time dynamic auction emulations, operatively coupled to the ADM component;
a UIM server-side component for acquiring bidder information and delivering data information from the ADM component, operatively coupled to the RDA and ADM components.
